(19) United States
(12) Patent Application Publication
(10) Pub. No.: US 2006/0035621 A1
(43) Pub. Date: Feb. 16, 2006

(54) Measurement device with modular communication interface

(76) Inventor: Marius Ghercioiu, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/186,932

(22) Filed: Jul. 21, 2005

Related U.S. Application Data
(60) Provisional application No. 60/590,160, filed on Jul. 21, 2004.

(51) Int. Cl. H04Q 7/20

(52) U.S. Cl. 455/403

(57) ABSTRACT

System and method for performing measurement operations. A device includes a data acquisition (DAQ) board, comprising a microcontroller with a processor, a memory operable to store program instructions for performing a measurement function, and I/O connectors coupled to the processor and memory; a communication interface module (CIM), implementing a first communication protocol, and operable to couple to the DAQ board and facilitate communication (e.g., wired or wireless) between the DAQ board and a host computer per the first protocol; and a power source for the DAQ board and CIM. The DAQ board may couple to sensors via the I/O connectors, receive sensor data from the sensors, and transmit the sensor data to the host computer via the CIM. The CIM may be replaced with a different CIM, implementing a second communication protocol, and operable to facilitate communication between the DAQ board and the host computer per the second protocol.

### PRIORITY DATA

This application claims benefit of priority to U.S. Provisional Patent Application Ser. No. 60/590,160, titled “Measurement Device With Modular Communication Interface”, filed Jul. 21, 2004, whose inventor is Marius Ghercioiu.

### FIELD OF THE INVENTION

The present invention relates to the fields of programming and embedded devices, and more particularly to a compact mobile measurement device that includes a modular communication interface.

### DESCRIPTION OF THE RELATED ART

Embedded measurement and control systems have been developed for a wide variety of applications, such as automated manufacturing and remote data collection, among others. Many applications may benefit from or require instrumentation that is independent from a desktop personal computer (PC) or workstation. One such class of instruments is mobile, e.g., handheld, measurement devices. Mobile measurement applications typically require equipment that is battery powered, relatively lightweight so it can be hand carried, and capable of communicating either wirelessly or through a physical plug with computers, such as a PCs or Personal Digital Assistant (PDA) devices.

### SUMMARY OF THE INVENTION

Various embodiments of a compact mobile measurement device with a modular communication interface are described. In some embodiments, the compact mobile measurement device comprises a wireless measurement device, operable to couple to and receive data from a sensor, and to transmit the data, e.g., via wireless (or wired) means, to a host computer system. Thus, the compact mobile measurement device may comprise or be comprised in a measurement system. Note that various embodiments of the present invention may comprise or be comprised in one or more of: a measurement system, a control system, and industrial automation system, a machine vision system, and a surveillance system, among others.

In one embodiment, the compact wireless measurement device, also referred to herein as “the measurement device,” may comprise a measurement device that is wireless, battery powered (or powered by some other portable power source), and may be used as a peripheral to a wireless enabled host computer (e.g., a personal computer, laptop, server, etc.) or PDA. In preferred embodiments, the device may have a small form factor, e.g., for ease of use and transport. In terms of measurement connectivity, the device may be used in any of the following ways, among others:
1. Interface to analog sensors via a voltage probe.
2. Interface to digital sensors via a digital cable.
3. Interface to smart analog sensors, where “smart” refers to the capability of these sensors to identify their presence to the measurement system, e.g., disclosing their name, manufacturer, and/or calibration constants, among others.
4. Source voltage via an analog output cable.

Component miniaturization has facilitated development of compact Mixed Signal ISP Flash MCU micro-controllers, e.g., incorporating high-speed 8051 core microcontrollers, with a substantial amount of memory, analog and digital peripherals, and clock sources. Such microcontrollers may be suitable for various embodiments of the present invention. It is noted, however, that other types of micro-controllers may also be used as desired.

Thus, in some embodiments the wireless measurement device includes a Mixed Signal ISP Flash MCU that incorporates two 16-bit analog input channels connected via a UART digital peripheral to an external communication interface. This interface is preferably a wireless radio board or module, such as, for example, a module that implements Bluetooth, 802.11a/b/g, ZigBee, proprietary protocol, e.g., a proprietary serial based wireless protocol, etc. In other embodiments, the communication interface may comprise a cabled interface such as USB (I or II), Serial, 1394, etc. Note that these protocols and buses are meant to be exemplary only, and are not intended to limit the present system to any particular set of protocols, buses, or interfaces. Note also that since the interface board is modular, the measurement device may easily be modified or customized to include any communication functionality or protocol desired. In other words, the modular nature of the communication interface allows the measurement device to be easily modified or adapted for any desired communication functionality. Thus, when new or other communication protocols or technologies become available, pre-existing measurement devices may readily be modified, e.g., by replacing the module with a different interface module, to take advantage of the new functionality.

In one embodiment, the wireless measurement device may be powered by onboard batteries, e.g., two AA size batteries. Power consumption preferably ranges from approximately 200 mA at 3.2V to approximately 330 mA at approximately 1.6V. Power consumption at a working voltage of 2.3V may be approximately 310 mA. Note that these ranges are exemplary only, and that other ranges of power consumption, operating voltage, and amperage, are also contemplated. Note also that other types of power sources are also contemplated, including, for example, wireless power transmission, e.g., microwave power transmission, solar or other photovoltaic power generation, AC power with DC adaptor, and so forth.

In some embodiments, the wireless measurement device may use BT type I/O connectors, as are well known in the art, although other I/O connector types are also contemplated.

In various embodiments, the measurement device's interface operations may be supported by various different platforms and operating systems (OSs). For example, with respect to computer and PDA OS support, numerous platforms and operating systems support different wireless standards, including, for example, Windows 2000/XP/Me, PocketPC2003, and PalmOS, among others. These exemplary OSs may support one or more embodiments of the wireless measurement device, depending, for example, on the type of wireless interface or cable interface that the device has.

In one embodiment, the wireless measurement device may utilize various wireless protocol built-in dynamic defect management and error correction technologies to protect data transmission, i.e., for data reliability.

In preferred embodiments, the wireless measurement device may provide a low cost wireless measurement solution. For example, with the built-in controller, a wide variety of low cost analog-digital converter (ADCs) and digital-analog converter (DACs) technologies can be used to create different versions of the device.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a wireless data acquisition (DAQ) system, according to one embodiment of the present invention;

FIGS. 2A and 2B are detailed illustrations of a compact mobile measurement device, according to one embodiment;

FIGS. 3-5 illustrate connectors and pin assignments for the compact mobile measurement device of FIG. 2A, according to one embodiment;

FIGS. 6A and 6B illustrate use of special signal connectors and a device case for the compact mobile measurement device, according to one embodiment;

FIGS. 7A and 7B are detailed illustrations of a general-purpose compact mobile measurement device, according to one embodiment;

FIGS. 8A and 8B illustrate connectors and pin assignments for the general-purpose compact mobile measurement device of FIG. 7A, according to one embodiment;

FIG. 9 illustrates an exemplary device case for the general-purpose compact mobile measurement device of FIG. 7A, according to one embodiment;

FIG. 10 illustrates an exemplary AC power adaptor suitable for use with various embodiments of the invention; and

FIG. 11 is a flowchart of a method for performing measurement operations, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation By Reference

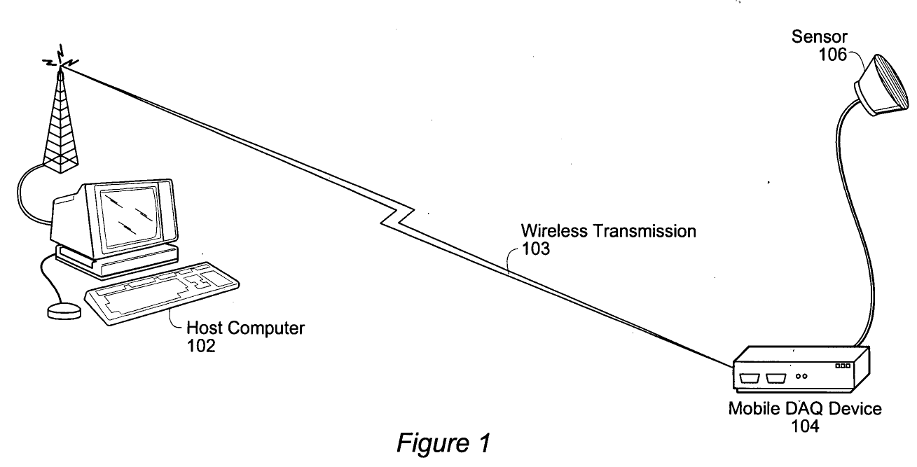

The following patents and/or publications are hereby incorporated by reference as though fully and completely set forth herein:
U.S. Provisional Patent Application Ser. No. 60/590,160, titled “Measurement Device With Modular Communication Interface”, filed Jul. 21, 2004, including Appendix A filed therewith.
U.S. Provisional Patent Application Ser. No. 60/459,918, titled “Deploying and Execution of a Graphical Program on an Embedded Device from a PDA”, filed Apr. 3, 2003.
U.S. patent application Ser. No. 10/733,735 titled “Deploying and Execution of a Graphical Program on an Embedded Device from a PDA”, filed Dec. 11, 2003.
U.S. patent application Ser. No. 10/733,735 titled “Modular Compact Sensor Interface”, filed Jun. 23, 2004.
U.S. patent application Ser. No. 10/283,758 titled “Wireless Deployment/Distributed Execution of Graphical Programs to Smart Sensors”, filed Oct. 30, 2002.
The LabVIEW graphical programming manuals, including the “G Programming Reference Manual”, available from National Instruments Corporation, are also hereby incorporated by reference in their entirety.
   FIG. 1—Wireless Measurement System

One embodiment of the present invention comprises a measurement device, e.g., a wireless data acquisition device, that is operable to execute programs to perform desired functions, such as voltage measurement, current measurement, resistance measurement, digital I/O, voltage generation, counter operation, and measurements using smart sensors. FIG. 1 illustrates an exemplary embodiment of a data acquisition (DAQ) system that uses such a device 104, where, for example, in this embodiment, the device 104 operates to receive signals from a sensor 106 and transmit the signals and/or related information via wireless means 103 to a host computer 102 (equipped with or coupled to a wireless receiver). The host computer may then operate to store, analyze, serve (e.g., make the data available for other devices networked to the computer), and/or otherwise process the received data.

In some embodiments, upon bootup, the measurement device may be operable to be detected by any host computer communicatively coupled to the measurement device that hosts the same communication protocol as the communication interface module.

It should be noted that in various embodiments, any number and types of sensors may be used as desired, including, for example, suites of different sensor types, e.g., acoustic, seismic, thermal, infrared, video, and magnetic sensors, among others. It should also be noted that the host computer 102 may be any type of computer, including a personal computer (e.g., a workstation), a laptop computer, a server, a personal digital assistant (PDA), and so forth, as desired. Note also that while in preferred embodiments, the device 104 communicates with the host computer via wireless transmission means 103, in some embodiments, this communication may be performed via a transmission cable or wired network. In other words, the communication interface module may include or be a wired communication interface, operable to couple to the host computer via a cable, where the wired communication module facilitates communication between the DAQ board and the host computer over the cable, e.g., per a protocol such as USB, Serial, and IEEE 1394, among others. While the descriptions below are directed to wireless embodiments, details not particularly related to wireless transmission may be considered to apply to wired embodiments, as well.

### EXAMPLE EMBODIMENTS

Below are described two exemplary embodiments of the device, specifically, an embodiment designed to accommodate a particular sensor type, and an embodiment directed to a more general implementation. It should be noted, however, that the particular embodiments described below are meant to be exemplary only, and are not intended to limit the invention to any particular form or functionality. In the following descriptions, components that are substantially similar are labeled with the same reference number or a variant thereof.

### Example Embodiment I

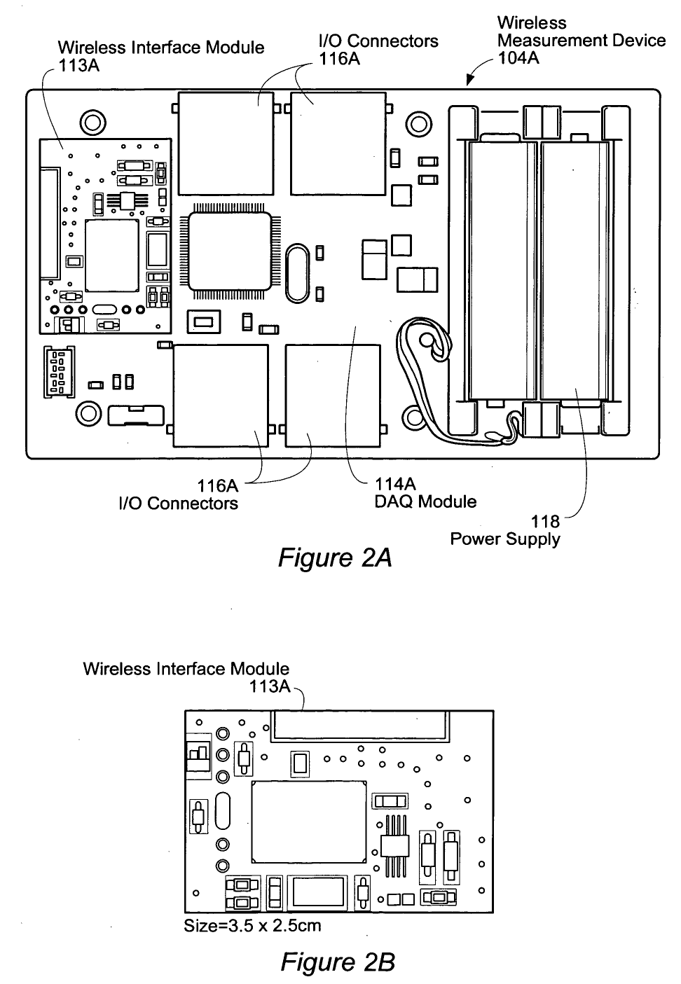

FIGS. 2A-6 illustrate embodiments of the device where some aspects of the device are directed to particular types or classes of sensors, specifically, a class of sensors provided by Vernier Software and Technology.

FIGS. 2A and 2B—Wireless Measurement Device

As noted above, in preferred embodiments, the measurement device comprises a wireless device, e.g., a wireless DAQ device 104. FIG. 2A illustrates one embodiment of a wireless DAQ device 104A that may be suitable for use in a wireless measurement system, such as that described above with reference to FIG. 1. Note that in preferred embodiments, described below, the components of the device 104A may be enclosed (at least partially) in a case or chassis. FIG. 2B illustrates the wireless interface module 113A included in the wireless DAQ device 104A of FIG. 2A.

In a preferred embodiment, the wireless measurement device comprises three primary components: a data acquisition (DAQ) module 114A, preferably including a microcontroller/memory and a plurality of I/O connectors 116, a plug-in, i.e., modular, interface module 113A, e.g., a radio daughter card or module 113A, that couples to the DAQ module 114A, and a power supply 118, e.g., a power source, e.g., one or more batteries, e.g., two AA batteries, as shown in FIG. 2A.

In one embodiment the DAQ module may be approximately 7 cm×3 cm×2 cm, although other form factors are also contemplated. For example, in various other embodiments, the DAQ module may be approximately 5 cm×5 cm×2 cm, approximately 4 cm×4 cm×2 cm, 6 cm×4 cm×2 cm, 7 cm×4 cm×2 cm, 4 cm×3 cm×2 cm, and so forth. Note that the last dimension (2 cm) is also approximate, and may have a similar range of values, e.g., may be between approximately 1 cm and approximately 3 cm, or, even approximately 4 cm, depending on the arrangement of components. As indicated in FIG. 2A, I/O connectors or ports 116A included on the DAQ module 114A may comprise analog and/or digital I/O connectors. As FIG. 2A also indicates, interface module 113A couples to the DAQ module 114A, and in this embodiment is shown situated on and above the DAQ module 114A.

FIG. 2B shows the interface module 113A of FIG. 2A in isolation. The interface module 113A, e.g., radio daughter card or module, may implement any of various communication protocols and interfaces. For example, in a preferred embodiment, the interface module may comprise a Bluetooth radio module, as shown in FIG. 2B. In other embodiments, the interface module may implement other protocols, such as, for example, 802.11a/b/g, ZigBee, a proprietary wireless protocol, e.g., a proprietary serial based wireless protocol, etc. In other embodiments, the communication interface may comprise a cabled interface such as USB (I or II), Serial, 1394, etc.

In the embodiment shown in FIG. 2B, the interface module 113A (e.g., radio daughter card or module) has a form factor of approximately 3 cm×2.5 cm. In another embodiment, the interface module 113A (e.g., radio daughter card or module) may have a form factor of approximately 4 cm×4 cm, although, as with the DAQ module, other form factors are also contemplated. For example, in various other embodiments, the radio card or module may be approximately 3 cm×3 cm, approximately 5 cm×5 cm, 5 cm×3 cm, 5 cm×4 cm, and so forth.

In one embodiment, the measurement device, i.e., the DAQ module 114A and the interface module 113A together, may be approximately 11 cm×6 cm×1.9 cm, although other compact form factors are also contemplated. Note that a primary feature of the measurement device is that the small form factor, as compared to desktop computers and workstation, laptop computers, etc., for example, facilitates easy hand transport and operation of the device.

In one exemplary embodiment, such as that illustrated in FIG. 2A, the DAQ board or module 114A may be build around a Mixed Signal ISP Flash MCU, such as the C8051F060 component provided by Silicon Laboratories, which comprises a mixed-signal flash microcontroller with two ultra-low power 16-bit one million samples per second (1MSPS) A/D converters. Additionally, one or more of the components and/or attributes may be specified or selected to be particularly suited for certain types of sensors. The following describes such an embodiment, although it should be noted that the particular components and functionality described are intended to be exemplary only, and are not intended to limit the measurement device to any particular form, components, or functionality.

In various embodiments, the power source comprise batteries, photovoltaic cells, fuel cells, a microwave receiver for receiving wireless transmitted power, or any other type of power source that facilitates portability.

The DAQ board or module 114A preferably offers channels for analog input, analog output, digital I/O and counter/timer operations. Further details of this particular embodiment are provided below, although, as noted above, these attributes are intended to be exemplary only, and are not intended to limit the device to any particular set of attributes or to any particular values of the attributes.

Analog Input

The analog input section of this embodiment may include two 16-bit inputs with a maximum scan rate of 700 KS/s (kilo-samples per second).

Input Characteristics
Number of channels: 2 SE, or 1 DIFF
Type of ADC: Successive approximations
Resolution: 16 bit
Maximum sampling rate:
700 KS/s in finite scan, max 2000 points
5 KHz in continuous acquisition
Input signal ranges:
SE: ±10 V, ±1 V
DIFF: ±10 V
Input coupling: DC
Maximum working voltage (signal + common mode): input should
remain within ±42 V of ground
Data transfers: programmed I/O
FIFO buffer size: 2,000 samples
Amplifier Characteristics
Input Impedance: 1 MegOhms
Input Coupling: DC
Overvoltage protection:
Channel to GND: 42 V AC, 60 V DC, Installation Category I
Channel to Channel: 42 V AC, 60 V DC, Installation Category I
Triggering

| | |
|---|---|
| Analog: | Channel 0 (level, window with settable levels) |
| Digital: | TTL DC coupled in DIO 1 - rising edge |

Analog Output
one 12-bit, [−2.5 V; 2.5 V], max output rate of 50 KS/sec
Output Characteristics
Number of channels: 1 SE
Resolution: 12 bit
Maximum sampling rate: 100 KS/s
Maximum buffer size 2000 points
Input signal ranges:
SE: ±2.5 V.
Digital I/O
Number of channels: 8 input/output, bit programmable.
Lines DIO 0, 1, 2, 3, 4, 5, 6, 7 input/output, bit programmable
Input: standard TTL logic voltage levels
Output: open collector, current drive capability total for 8 lines is 100 mA
Protection: 42 Volts
Counter 32-bit
Number of channels: 1, 32-bit
Counter measurement wiring: (signal+ in EXT-T/C, signal− in GND)
Compatibility: TTL
Data transfers: programmed I/O
Counter Measurement Wiring
+ signal wired to DIO
− signal wired to GND
Triggers
Digital Trigger
Number of triggers: 1 (ADC 12 bit)
Digital Trigger wiring:
signal+ in CNV-TRG (D1 —YELLOW CLIPS)
signal− in GND (BLACK CLIPS)
Compatibility: TTL
Coupling: DC
Protection: −0.3 V . . . 40 V
Analog Trigger
Number of triggers: 1 (ADC 16 bit)
Analog Trigger wiring for ch0: (signal+ in AN0, signal− in AGND)
Note: Total buffer (ADC 16 bit + DAC 0) storage capacity may be
less than or equal to approximately 2000 points.
Power Switch
Used to power the device ON/OFF.

LED Indicators

In one embodiment, the wireless measurement device has two LEDs (light emitting diodes). For example, a Power ON/Error LED may include a red LED indicating the power-on condition by flickering briefly at device power-on. In this embodiment, if an error occurs during application execution on the wireless measurement device, the red LED may stay on for a longer period of time to indicate the error condition. In one embodiment, the Power ON/Error LED may indicate specific error conditions by blinking at different rates or in different patterns.

A blue LED, e.g., a Bluetooth LED, may indicate when the measurement device comes out of an idle state and is communicating, e.g., via wireless Bluetooth, with the host computer or PDA device.

Note that in other embodiments, other or additional LEDs may be used to indicate device and operation status. In further embodiments, other indicators may be used, including for example, LCDs (liquid crystal displays), low-power bulbs, and so forth, as desired.

Signal Probes

In some embodiments, the measurement device may include probes for design, development, debugging, and operation of the device. For example, one or more of the following types of probes may be used with the wireless measurement device:
Analog Signal probes—large scope clips RED/BLACK;
Digital Signal probes—small scope clips RED/RED/RED/BLACK;
Analog Output probe—small scope clips RED/BLACK; and
Smart Sensor probes.

As noted earlier, the above describes one exemplary embodiment of the measurement device, and other embodiments may have different characteristics and features consistent with the scope of the present invention.

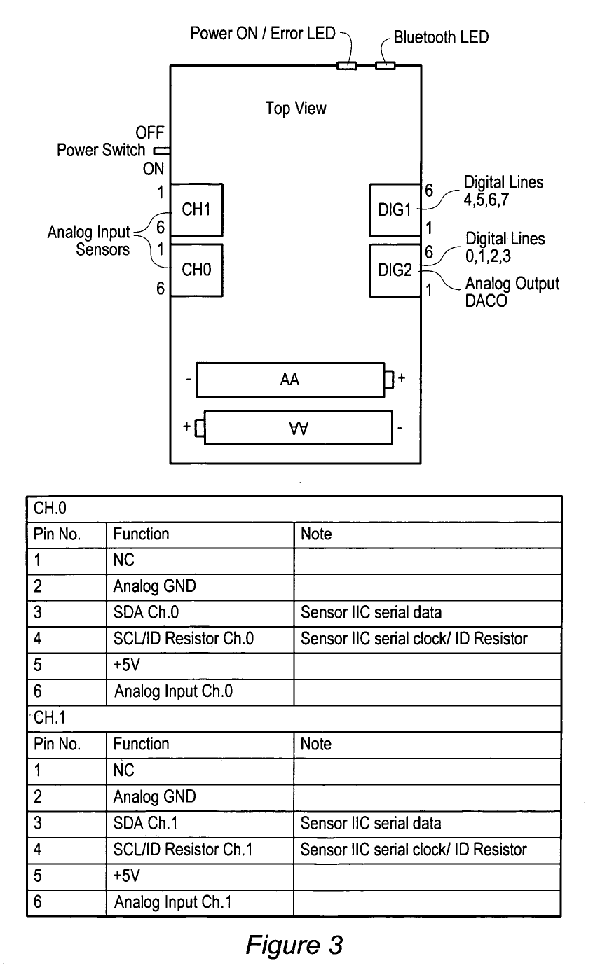

FIGS. 3-5—Wireless Measurement Device Connectors And Pin Assignments

As noted above, the measurement device preferably includes a plurality of connectors, e.g., pin connectors, for sending and receiving signals and data to and from other devices, including analog input channels, analog output channels, and digital I/O lines. One embodiment of connector layout and pin assignments is shown and described below with reference to FIGS. 3-5.

FIG. 3 is a high-level diagram of analog and digital I/O for the measurement device, according to one embodiment. Additionally, FIG. 3 illustrates a power switch, Bluetooth indicator, and power on/error indicator (light emitting diode (LED)). As FIG. 3 shows, in this embodiment, the device includes two 6-pin connectors for receiving analog input, e.g., from sensors, to channels 1 and 2, respectively. As FIG. 3 also shows, each channel includes respective pins for receiving analog input signals (pin 6), analog ground (pin 2), and a pin for accessing +5 Volt power (pin 5) if needed. Note that in this embodiment, pin 1 of each channel is not connected (NC), although in other embodiments, this pin may be used for any additional functionality as desired.

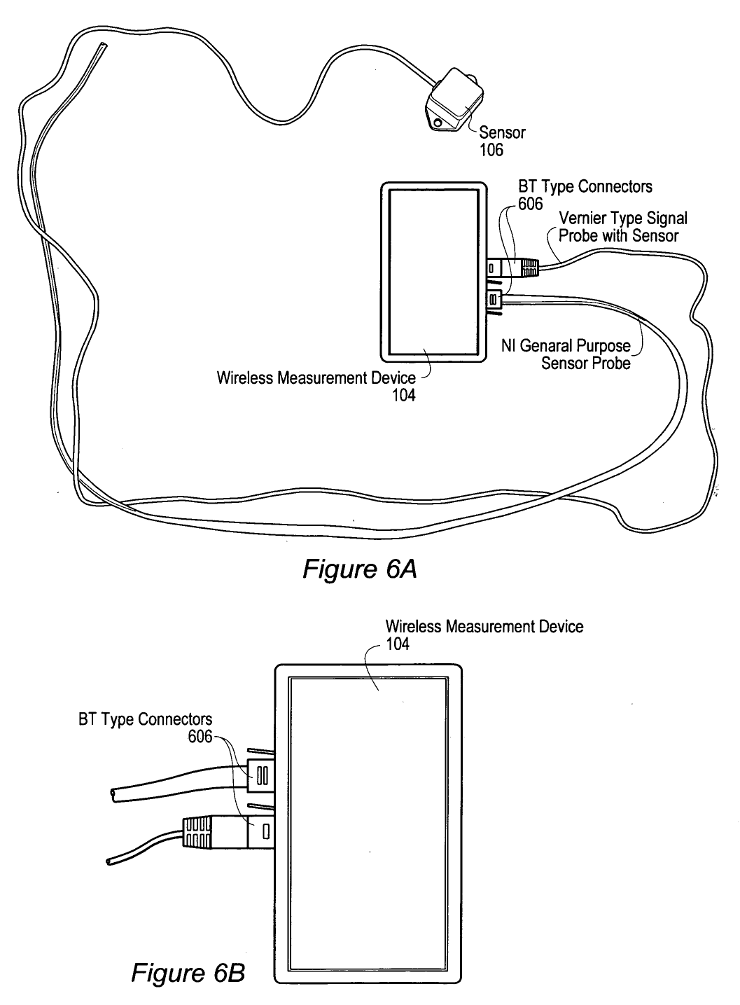

As noted above, in various embodiments, some aspects of the device may be directed to particular types or classes of sensor. For example, some embodiments may specifically accommodate a class of sensors made by Vernier Software and Technology, which may have certain particularities. For example, these sensors may utilize special connectors, specifically, BT type connectors, as described below with reference to FIGS. 6A and 6B, and may use a special protocol to detect the type of the sensor and its calibration constants. More specifically, communication with the Vernier sensor may be performed via 2-wire communication, specifically, using two digital lines: SDA (pin 3) and SCL/ID (pin 4), as indicated in FIG. 3, where the SCL/ID pin allows the Vernier sensor to communicate sensor identification (ID) information to the measurement device as well as a serial clock signal, and where the SDA pin facilitates serial digital communication between the sensor and the device, e.g., to receive sensor specific data, such as, for example, calibration constants. Thus, in some embodiments, at least one of the one or more sensors may be a smart sensor which, upon coupling to the measurement device, may transmit sensor information to the measurement device, where the sensor information includes one or more of: identification information for the sensor, configuration information for the sensor, and communication information for the sensor.

Thus, in this embodiment, the device may determine the ID and nature of the sensor prior to use, i.e., may confirm that the sensor is appropriate for use before proceeding. Note that as these lines are included on each channel of the device, two Vernier sensors may be connected and used at the same time, i.e., one per channel, if desired. Of course, in other embodiments, any types of sensors may be used as desired.

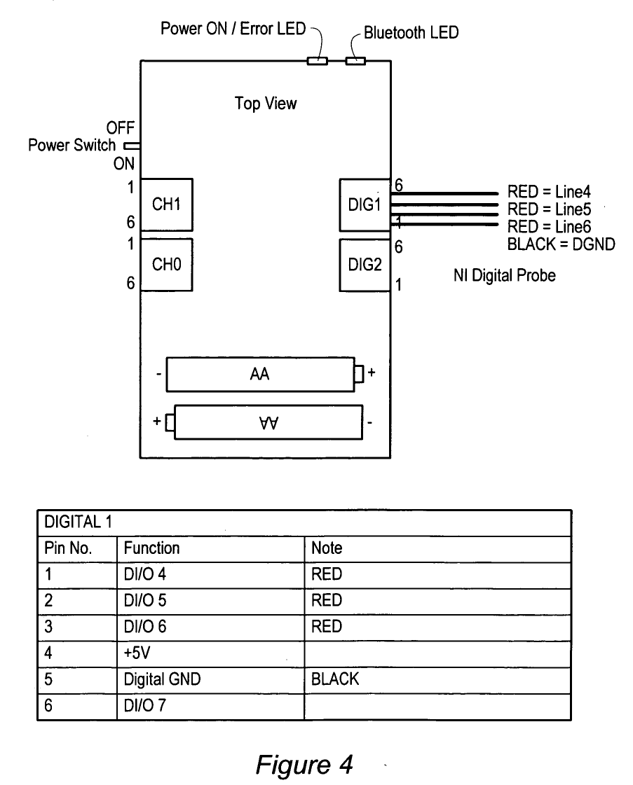

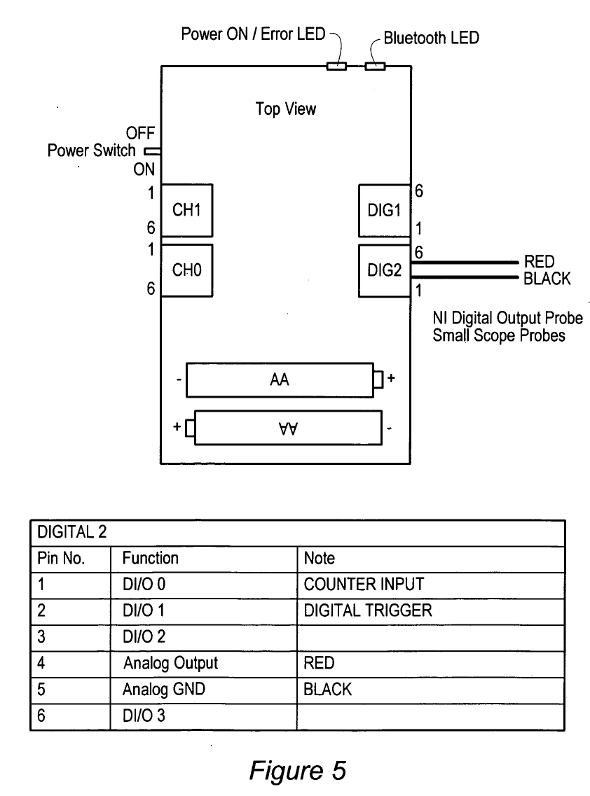

In some embodiments, in addition to two analog channels, the device may include one or more digital channels. FIGS. 4 and 5 illustrate exemplary digital I/O connectors and pin assignments, according to one embodiment of the device. More specifically, FIG. 4 illustrates pin assignments for a first digital connector DIG1, and FIG. 5 illustrates pin assignments for a second digital connector DIG2.

As FIG. 4 shows, in this embodiment, pins 1-3 of the first digital connector (DIG1) are assigned to digital I/O lines 4-6 (RED), while pin 5 is assigned to digital ground (BLACK). One or more of these digital I/O lines may be used with or as part of a digital probe, e.g., such as provided by National Instruments Corporation. Note that, similar to the analog channels described above, pin 4 provides access to +5 Volt power if needed. Pin 6 is assigned to a fourth digital I/O line—DI/O 7, which may be used for any functionality as desired.

As indicated in FIG. 5, in this embodiment, pins 1-3 and 6 are assigned to digital I/O lines 1-2 and 3, respectively, where pin 1 (DI/O 0) is used for counter input and pin 2 (DI/O 1) is used to facilitate a digital trigger. Pins 3 and 6 (DI/O 2 and DI/O 3) may be programmed and used as desired. As FIG. 5 also indicates, pin 4 may provide for analog output (RED), and pin 5 may provide for analog ground (BLACK). These lines may facilitate use of analog probes, such as provided by National Instruments Corporation, and small oscilloscope probes, as are well known in the art.

FIGS. 6A and 6B

As noted above, some embodiments may utilize special connectors, e.g., BT type connectors 606, as shown in FIGS. 6A and 6B, e.g., for use with Vernier type sensors and certain signal probes. FIG. 6A illustrates such an embodiment, and also shows the device coupled to a Vernier type signal probe with sensor, where the sensor is coupled to the device via the first digital connector (see FIG. 4, described above). In this embodiment, the second digital connector (see FIG. 5, described above) is utilized for a general purpose signal probe. As FIG. 6A also shows, in preferred embodiments, the components of the device may be enclosed in a case or chassis, described below. FIG. 6B provides another illustration of the BT connectors and case for the device.

Device Case

In various embodiments, the measurement device may be comprised in a case or chassis, e.g., for protection of the components, ease of use, and/or aesthetics. In the embodiment shown below, the device uses a PacTec case RC-24-9VB/2AA, although any other type of case or chassis may be used as desired. For example, different cases or chassis may be used for different applications and operating environments, e.g., for outdoor use, the device may comprise a ruggedized, air or water-tight case, while for indoor use, lighter, less expensive cases may be used.

In keeping with the portable, handheld nature of the measurement device, in some embodiments, belt/pocket clips may be included in or added to the case, e.g., belt clips from OKW, model number A9172109.

Size And Weight of the Wireless Measurement Device

As noted above, various embodiments of the wireless measurement device may have a range of sizes. For example, in one embodiment, the device may have a form factor of approximately 11 cm×6 cm×1.9 cm, i.e., approximately 4.33″×2.33″×0.75″, and may weigh approximately 82 g, e.g., approximately 2.9 oz, although some embodiments may be heavier or lighter, depending upon the particular materials used, e.g., for the case.

Power Consumption

As noted above, in a preferred embodiment, the wireless measurement device may be powered by onboard batteries, e.g., two AA size batteries. Power consumption may range from 200 mA at 3.2V to 330 mA at 1.6V. Power consumption at a working voltage of 2.3V may be approximately 310 mA. Note that these power and voltage levels are exemplary only, and that the values may differ in various embodiments and applications.

In the embodiment shown in the above-described figures, the power switch is located on the left side of the case. When the Power Switch is turned ON, the red LED (located to the right of the signal connector) will turn ON for a brief period, e.g., a couple of seconds, then may turn OFF to save power, thereby indicating that the wireless measurement device is ON.

Example: Bluetooth Radio Board

As noted above, in various exemplary embodiments, the wireless measurement device radio (interface module 113A) may be based on one or more of: the Bluetooth LMX9820A from National Semiconductor, the WiPort 802.11 wireless Ethernet module from Lantronix, the Digi Connect Wi-EM 802.11 wireless Ethernet module from Digi Connect, and the ZigBee wireless module from Freescale semiconductor, among others. The LMX9820A Bluetooth model is illustrated in FIG. 2B, and described above.

Serial Baud Rate

In the Bluetooth embodiment shown and described above (see FIGS. 2A and 2B), the serial baud rate may be set to 115200. This is the maximum baud rate that the two devices, i.e., the Bluetooth radio board and the microcontroller on the DAQ board, can sustain. The baud rate is preferably fixed, and so may not be changed by the user. Of course, in other embodiments, e.g., using other interface modules and/or microcontrollers, the baud rate may be different as desired or required.

Drivers

As is well known in the art, most hardware devices that are to be operated from a computer require driver programs, i.e., software to control a hardware component or peripheral device of a computer. Thus, the memory may be operable to store driver software which is executable by the processor to operate the one or more components of the device, e.g., the communication interface module. In some embodiments, the wireless measurement device may be further operable to receive driver programs, and store the received driver programs, where the driver programs enable operation of the device, e.g., the DAQ board, the communication interface module, and/or the one or more sensors.

In one embodiment, the driver programs (and other software) may be provided to or received by the wireless measurement device via a JTAG interface that resides on the DAQ module. For example, in one Bluetooth embodiment, the wireless measurement device may be operable to communicate with a Bluetooth adaptor of a host computer system or PDA. Prior to communication the wireless measurement device may need to be loaded with a set of the driver programs from the host system, e.g., driver programs that provide both the measurement and communication via Bluetooth interface capability of the wireless measurement device. Once the wireless measurement device has received the driver program(s), it may be booted up, and may then operate to perform the types of measurements that are required by the computer or PDA.

In other embodiments, the wireless measurement device may be operable to receive a set of the driver programs that provide measurement and communication via 802.11 a/b/g interface capability, ZigBee interface capability, and/or a proprietary protocol (or any other interface capability) as desired or required.

In other words, an initial set of driver programs corresponding to DAQ capability of the wireless measurement device 104 may be modified for the wireless communication method depending on the type of radio board that is attached to the device in the current application. A unique and finite set of measurement functions may be connected to different wireless communication protocols, according to the hardware architecture of the device under construction.

Note that because the communication interface 113 is modular, any of the above technologies or protocols (or others not listed) may be used as needed, depending on the current application. Moreover, in some embodiments, multiple communication protocols may be implemented concurrently on or by the measurement device as desired.

Programs

The programs used to operate and/or communicate with the measurement device may be of any type, including text-based programming languages such as C, C++, Basic, JAVA, etc., as well as graphical programs, such as those developed in the “G” graphical programming language using the LabVIEW graphical programming system provided by National Instruments, which comprise a plurality of interconnected nodes or icons which visually indicate functionality of the program, and may comprise one or more of data flow, control flow, or execution flow diagrams which are executable to perform the specified functionality.

These programs may include programs stored and executed by the host computer, the measurement device, and/or smart sensors, and may include application software, driver software, or any other type of software for operating or communicating with the measurement device.

### Example Embodiment II

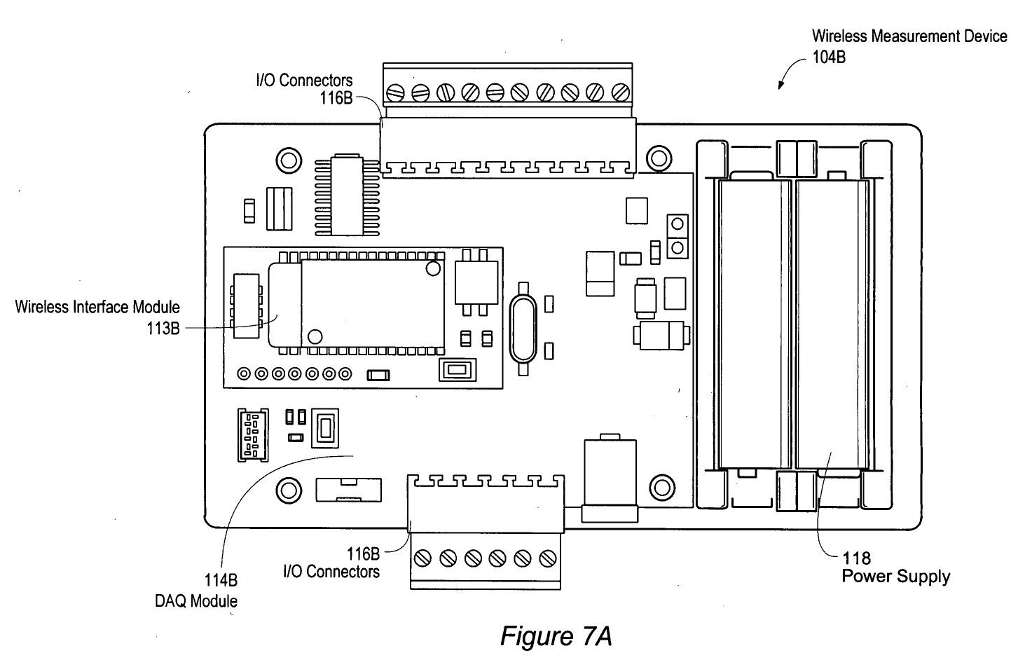

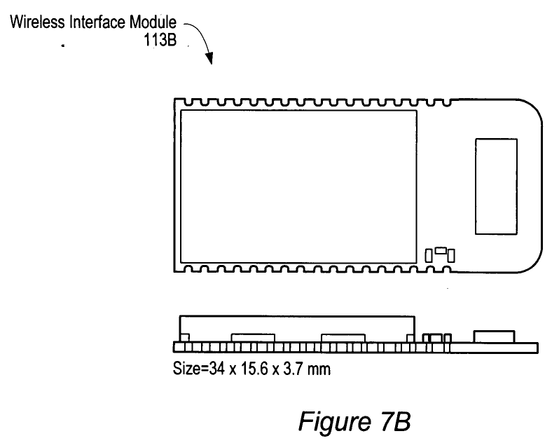

FIGS. 7-11 illustrate more general embodiments of the device, e.g., which may be suitable for use with a wide variety of different sensor types and for a broad range of applications. This embodiment may be referred to as a mobile general-purpose measurement device, or simply the GP device. It should be noted that various other embodiments of the measurement device may include any of the features described herein with respect to exemplary embodiments I and/or II.

FIGS. 7A and 7B—Wireless Measurement Device

As noted above, in preferred embodiments, the measurement device comprises a wireless device, e.g., a wireless DAQ device 104. FIG. 7A illustrates another embodiment of a wireless DAQ device that may be suitable for use in a wireless measurement system, such as that described above with reference to FIG. 1. FIG. 7B illustrates an exemplary wireless interface module 113B.

In preferred embodiments, the GP device may include general-purpose analog input/output/and digital functionality, and thus may not support requirements of some sensor classes or types, e.g., Vernier sensors and their communication protocol, described above.

Similar to the embodiment described above, in preferred embodiments, the GP device may include three primary components: a DAQ module 114B with I/O connectors 116B, a plug-in wireless interface module 113B, e.g., a Bluetooth radio daughter card, and a power supply 118, e.g., two AA batteries. In some embodiments, the DAQ module 114B may be approximately 7 cm×3 cm, although any other compact form factors are also contemplated, e.g., 5 cm×5 cm, 6 cm×4 cm, and so forth. Similarly, in one embodiment, the plug-in Bluetooth radio daughter card may have dimensions of approximately 4 cm×4 cm, although other sizes are also contemplated, e.g., approximately 3 cm×3 cm, approximately 3 cm×4 cm, approximately 2 cm×4 cm, approximately 3 cm×2 cm, and so forth.

Similar to the embodiment described above, in the embodiment of FIG. 7A, the interface module 113B is situated on/above the DAQ module 114B. In a preferred embodiment, the interface module 113B of the GP device may comprise a Bluetooth radio board, such as model EYMF2CAMM-XX provided by Taiyo Yuden.

As FIG. 7B shows, in this particular embodiment, the Bluetooth radio board (interface module 113B) is approximately 34 mm×15.6 mm×3.7 mm in size, although other form factors may be used as desired.

The following presents a more detailed description of the GP device components, according to one embodiment.

DAQ Module

In some embodiments, the DAQ module 114B of the GP device may be build around the C8051F060 microcontroller from Silicon Laboratories, which is a mixed-signal flash microcontroller with two ultra-low power 16-bit one million samples per second (1MSPS) A/D converters. The DAQ module or board 114B preferably includes channels for analog input, analog output, digital I/O, and counter/timer operations.

It should be noted that the attributes and specifications provided below are meant to be exemplary only, and are not intended to limit the GP device to any particular components, attributes, or settings.

Analog Input
AI0, AI1, 16-bit inputs with a max scan rate of 700 KS/s
Input Characteristics
Number of channels: 2 SE, or 1 DIFF
Type of ADC: Successive approximations
Resolution: 16 bit
Maximum sampling rate:
700 KS/s in finite scan, max 2000 points
5 KHz in continuous acquisition
Input signal ranges
SE: ±10 V, ±1 V
DIFF: ±10 V
Input coupling: DC
Maximum working voltage (signal + common mode): input should
remain within ±42 V of ground
Data transfers: programmed I/O
FIFO buffer size: 2,000 samples
Transfer Characteristics
Relative accuracy: TBD
Amplifier Characteristics
Input Impedance: 1 MegOhms
Input Coupling: DC
Overvoltage protection:
Channel to GND: 42 V AC, 60 V DC, Installation Category I
Channel to Channel: 42 V AC, 60 V DC, Installation Category I
Triggering
Analog: Channel 0 (level, window with settable levels)
Digital: TTL DC coupled in DIO 1 - rising edge
Analog Output
DAC0, 12-bit, [−2.5 V; 2.5 V], max output rate of 50 KS/sec
Output Characteristics
Number of channels: 1 SE
Resolution: 12 bit
Maximum sampling rate: 100 KS/s
Maximum buffer size 2000 points
Input signal ranges: SE: ±2.5 V
Digital I/O
Number of channels: 8 input/output, bit programmable
Lines DIO 0, 1, 2, 3, 4, 5, 6, 7 input/output, bit programmable
Input: standard TTL logic voltage levels
Output: open collector, current drive capability total for 8 lines is 100 mA
Protection: 42 Volts
Counter 32-bit
Number of channels: 1, 32-bit
Counter measurement wiring: (signal+ in EXT-T/C, signal− in GND)
Compatibility: TTL
Data transfers: programmed I/O
Counter Measurement Wiring
+ signal wired to DIO0
− signal wired to GND
Triggers
Digital Trigger
Number of triggers: 1 (ADC 12 bit)
Digital Trigger wiring:
signal+ in DIO1
signal− in GND
Compatibility: TTL
Coupling: DC
Protection: −0.3 V . . . 40 V
Analog Trigger
Number of triggers: 1 (ADC 16 bit)
Analog Trigger wiring for ch0: (signal+ in AN0, signal− in AGND)
Note: Total buffer (ADC 16 bit + DAC 0) storage capacity may be less
than or equal to approximately 2000 points.

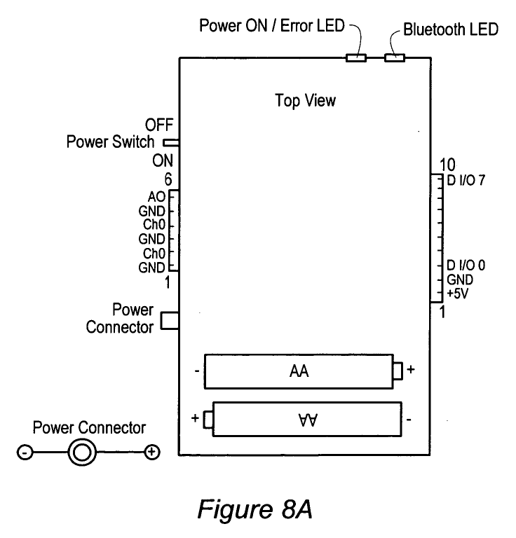

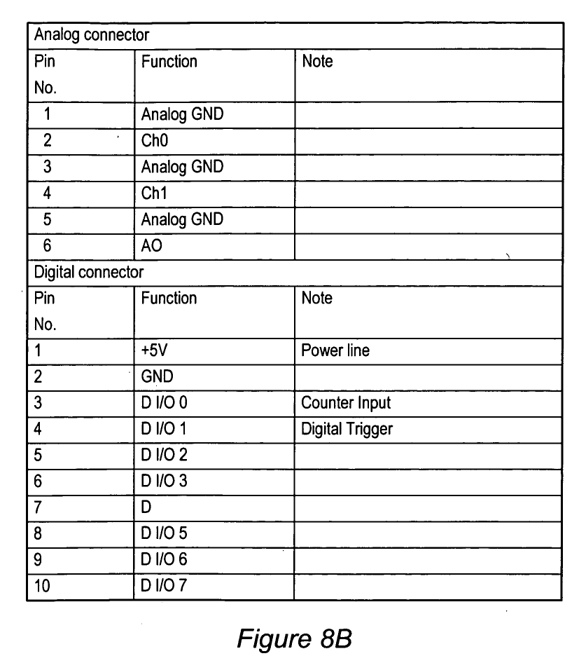

FIGS. 8A And 8B—Wireless Measurement Device Connectors And Pin Assignments

The measurement device preferably includes a plurality of connectors, e.g., pin connectors, for sending and receiving signals and data to and from other devices, including analog input channels, analog output channels, and digital I/O lines. One embodiment of connector layout and pin assignments is shown and described below with reference to FIGS. 8A and 8B.

FIG. 8A is a high-level diagram of analog and digital I/O for the measurement device, according to one embodiment. Additionally, similar to FIG. 3 described above, FIG. 8A illustrates a power switch, Bluetooth indicator (e.g., a blue LED), and power on/error indicator (e.g., a red LED). Additionally, in this embodiment, a power connection is also included, e.g., for connecting to an AC power source, described in detail below. As FIG. 8A illustrates, in this embodiment, the GP device includes a 6-pin connector for receiving analog input, e.g., from sensors, to channels 1 and 2, respectively and for sending analog output. More specifically, as illustrated in FIG. 8A, and indicated in FIG. 8B, pins 2 and 4 are operable to receive analog input for channels 0 and 1, respectively, pins 3 and 5 provide analog ground for channels 0 and 1, respectively, and pin 6 provides for analog output. Of course, these pin assignments are meant to be exemplary only, and any other assignments may be made as desired.

As also indicated in FIGS. 8A and 8B, the GP device preferably includes digital I/O capabilities, as well. More specifically, in this embodiment, a 10-pin connector may be provided to facilitate digital communication with the GP device. As shown, pin 2 may provide a digital ground, and pins 3-10 may implement digital I/O lines (DI/O) 0-8. In this particular configuration or assignment, DI/O 0 (pin 3) is configured for counter input, and DI/O 1 (pin 4) is configured as a digital trigger line. Note that pin 1 is used to deliver +5 Volts power if needed.

Similar to exemplary embodiment I described above, the GP device preferably includes a power switch, used to power the GP device ON/OFF, and LEDs for signaling status of the GP device. For example, in the embodiment shown, the GP device may include two LEDs: a red error LED and a blue “communication” LED. For example, if an error occurs during application execution on the GP device, the red LED may remain on for a longer period of time. The blue LED may indicate when the GP device exits the idle state and is communicating, e.g., via wireless Bluetooth, with the host computer or PDA device.

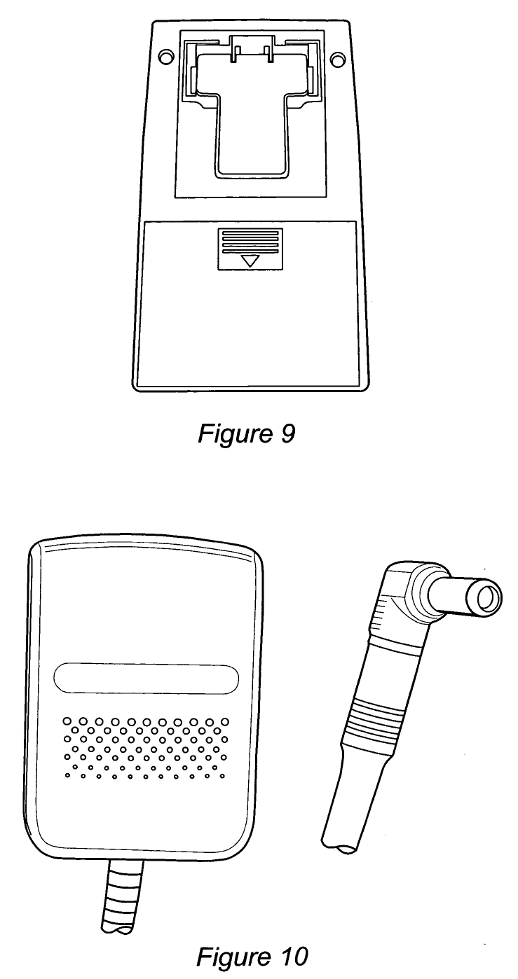

FIG. 9—GP Device Case

As noted above, in preferred embodiments, the GP device includes a case or chassis, e.g., for protection of the components, ease of use, and/or aesthetics. An exemplary device case suitable for some embodiments of the GP device is the PacTec case RC-24-9VB/2AA PBC, illustrated in FIG. 9. Note that this model includes a belt or pocket clip for ease of carrying. In other embodiments, other device cases may be used as desired.

Size And Weight of the GP Device

As noted above, one of the primary beneficial features of the present invention is its portability, due to the small form factor and light weight of the device. For example, in one embodiment, the GP device (including case) may be approximately 11 cm×6 cm×1.9 cm (i.e., approximately 4.33 in×2.33 in×0.75 in) and may weight approximately 82 g (i.e., approximately 2.9 oz), although other sizes and weights are also contemplated, so long as they facilitate or accommodate easy portability, e.g., as long as the device may be easily carried by a human.

Serial Baud Rate

Note that the serial baud rate achievable by the device may depend upon the particular components used. For example, in some embodiments, the serial baud rate may be set to approximately 115200, which is the maximum baud rate that the two devices—the Bluetooth radio board 113B and the microcontroller on the DAQ board described above—can sustain. Note that the baud rate is preferably fixed, and thus may not be changed by the user. Of course, use of other components (microcontrollers, interface modules, etc.) may result in different transmission rates.

Power Consumption

In the embodiments described herein, the GP device may be powered by batteries, e.g., two AA size batteries, or via an AC adapter, i.e., in some embodiments, the power source may be operable to couple to an AC power adaptor, receive the DC power from the AC power adaptor, and provide the DC power to the measurement device. Additionally, in some embodiments, the power source may include a battery (or multiple batteries), and the measurement device may be operable to charge the battery with the DC power provided by the AC power adaptor.

Power consumption may range from approximately 200 mA at 3.2V to approximately 330 mA at 1.6V. Power consumption at a working voltage of 2.3V may be approximately 310 mA.

In some embodiments, when the power switch is ON, the red LED may turn ON for a couple of seconds (i.e., for a brief time period), and then may turn OFF to save power. This brief cycling of the red LED may thus indicate that the GP device is ON.

In order to power the GP device from an AC adapter, various AC power adaptors may be used. For example, virtually any power adapter specified at: 5V, 6V or 7.5V, at 500 mA or more, with a 2.5 mm coax connector, center negative, may work. For example, a 5V, 500 mA, PDA type power adapter that uses a 2.5 mm coax plug, center negative may be suitable for use. Other suitable adaptors include, but are not limited to:
6V, 1800 mA with type N connector (O.D.: 5.5 mm. I.D.: 2.5 mm); and 6V, 800 mA with type N connector (O.D.: 5.5 mm. I.D.: 2.5 mm), the latter which is illustrated in FIG. 10. As may be seen, this exemplary AC power adaptor, provided by Radio Shack, provides 6V, 800 mA, and has a compact form factor.

Thus, in some embodiments, the measurement device includes a DAQ board 114 that includes a microcontroller, comprising a processor, a memory, coupled to the processor, where the memory is operable to store program instructions executable by the processor to perform a measurement function, one or more ADC converters and/or one or more DAC converters, coupled to the processor, and a plurality of digital lines, coupled to the processor. Additionally, as noted above, the DAQ board 114 may also include a plurality of I/O connectors coupled to the processor and memory, wherein a first subset of the I/O connectors are coupled to the plurality of digital lines, wherein a second subset of the I/O connectors are coupled to the one or more ADC converters and/or the one or more DAC converters, and wherein the measurement device couples to the one or more sensors via one or more of the second subset of I/O connectors.

The measurement device 114 may also include a communication interface module, implementing a first communication protocol, and operable to couple to the DAQ board, and provide for communication between the DAQ board and a host computer in accordance with the first protocol, as well as a power source, coupled to the DAQ board, and operable to provide power to the DAQ board and the communication interface module. The DAQ board is preferably operable to couple to one or more sensors via one or more of the plurality of I/O connectors, receive sensor data from the one or more sensors, and transmit the sensor data to the host computer via the communication interface.

As also described above, the communication interface module is preferably operable to be uncoupled from the DAQ board and replaced with a different communication interface module, implementing a second communication protocol, and operable to provide for communication between the DAQ board and the host computer in accordance with the second protocol.

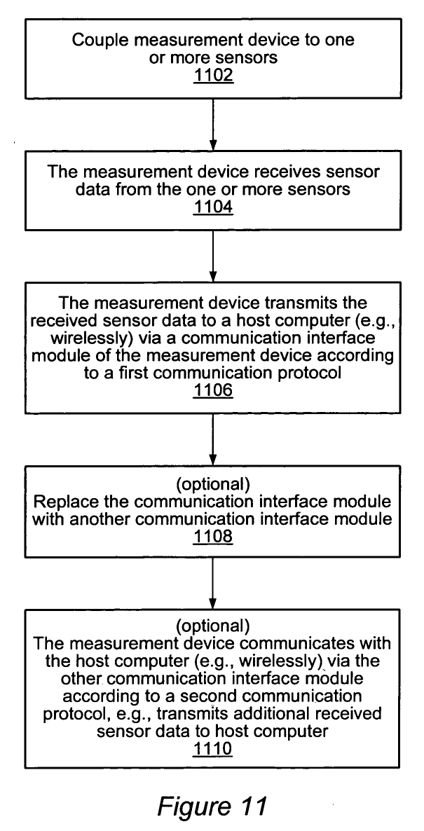

FIG. 11—Method For Performing Measurement Operations

FIG. 11 is a high-level flowchart of a method for performing measurement operations, according to one embodiment. Note that the method is preferably performed with an embodiment of the compact mobile measurement device described above. It should also be noted that in various embodiments, some of the method elements shown may be performed concurrently, in a different order than shown, or may be omitted. Additional method elements may also be performed as desired. As shown, this method may operate as follows.

In 1102, a measurement device may be coupled to one or more sensors, where the measurement device comprises an embodiment of the measurement device described above. In other words, the measurement device preferably includes a data acquisition (DAQ) board with processor, memory, and a plurality of I/O connectors coupled to the processor and memory, where the measurement device couples to the one or more sensors via one or more of the I/O connectors; a communication interface module that facilitates communication between the DAQ board and a host computer, e.g., wirelessly; and a power source, coupled to the DAQ board, and operable to provide power to the DAQ board and the communication interface module.

In 1104, sensor data may be received from the one or more sensors. For example, the DAQ board may receive the sensor data via one or more of the I/O connectors. As noted above, in some embodiments, at least a portion of the I/O connectors may be coupled to one or more ADC converters and/or one or more DAC converters, where the measurement device couples to the one or more sensors via one or more of the second subset of I/O connectors. Thus, the received sensor data may be converted, e.g., from analog signals to digital signals, for storage and use by the measurement device.

In 1106, the sensor data may be transmitted to the host computer via the communication interface. As described above, in various embodiments, the sensor data may be transmitted to the host computer in a wired (e.g., cable) or wireless manner (e.g., via Bluetooth).

In 1108, the communication interface module may be replaced with another, different, communication interface module. In other words, the communication-interface module may optionally be uncoupled from the DAQ board, and a different communication interface module, implementing a second communication protocol, may be coupled to the DAQ board.

In 1110, the DAQ board may communicate with the host computer in accordance with the second protocol. For example, the DAQ board may receive additional sensor data from the sensor(s), and may transmit the additional sensor data to the host computer (in a wired or wireless manner) via the other communication interface module according to the second protocol.

It should be noted that in various embodiments, the method may also include method elements implementing or performing any of the functionality described above with respect to the various embodiments of the measurement device and its uses.

Thus, various embodiments of the mobile measurement device described herein may provide improved means for performing measurement tasks or operations, e.g., for measurement, control, automation, surveillance, and any other applications where portability of the measurement device may be beneficial.

### APPENDIX

The btDAQ/100 manual, Version 5.0, 2005, is attached hereto as Appendix A, and describes particular embodiments of the compact mobile measurement device, although it should be noted that any of the features and functionality described therein, and variations thereof, may be included in various other embodiments as well. Moreover, it should be noted that the embodiments described in the appendix are meant to be exemplary only, and are not intended to limit the invention to any particular set of functions or components.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A measurement device, comprising,
a data acquisition (DAQ) board, comprising:
a microcontroller, comprising:
a processor;
a memory, coupled to the processor, wherein the memory is operable to store program instructions executable by the processor to perform a measurement function;
one or more ADC converters and/or one or more DAC converters, coupled to the processor; and
a plurality of digital lines, coupled to the processor;
a plurality of I/O connectors coupled to the processor and memory, wherein a first subset of the I/O connectors are coupled to the plurality of digital lines, wherein a second subset of the I/O connectors are coupled to the one or more ADC converters and/or the one or more DAC converters, and wherein the measurement device couples to the one or more sensors via one or more of the second subset of I/O connectors; and
a communication interface module, implementing a first communication protocol, and operable to:
couple to the DAQ board; and
provide for communication between the DAQ board and a host computer in accordance with the first protocol; and
a power source, coupled to the DAQ board, and operable to provide power to the DAQ board and the communication interface module;
wherein the DAQ board is operable to:
couple to one or more sensors via one or more of the plurality of I/O connectors;
receive sensor data from the one or more sensors; and
transmit the sensor data to the host computer via the communication interface; and
wherein the communication interface module is further operable to be uncoupled from the DAQ board and replaced with a different communication interface module, implementing a second communication protocol, and operable to provide for communication between the DAQ board and the host computer in accordance with the second protocol.

2. The measurement device of claim 1, wherein the communication interface module comprises a wireless communication module, wherein the host computer comprises a wireless communication interface, and wherein the wireless communication module facilitates wireless communication between the DAQ board and the host computer.

3. The measurement device of claim 2, wherein the wireless communication module implements one or more of:
Bluetooth;
IEEE 802.11 a/b/g;
ZigBee; and
a proprietary serial based wireless protocol.

4. The measurement device of claim 1, wherein the communication interface module comprises a wired communication interface, operable to couple to the host computer via a cable, and wherein the wired communication module facilitates communication between the DAQ board and the host computer over the cable.

5. The measurement device of claim 4, wherein the wired communication module implements one or more of:
USB;
Serial; and
IEEE 1394.

6. The measurement device of claim 1, wherein the microcontroller comprises a Mixed Signal ISP Flash MCU.

7. The measurement device of claim 1, wherein the memory is further operable to store driver software which is executable by the processor to operate the communication interface module.

8. The measurement device of claim 1, wherein the measurement device is further operable to:
receive one or more driver programs from the host computer over the communication interface module; and
store the received one or more driver programs, wherein the one or more driver programs are executable by the processor to operate one or more of:
the DAQ board;
the communication interface module; and
the one or more sensors.

9. The measurement device of claim 1, wherein, upon bootup, the measurement device is operable to be detected by any host computer communicatively coupled to the measurement device that hosts the same communication protocol as the communication interface module.

10. The measurement device of claim 1, wherein at least one of the one or more sensors comprises a smart sensor which is operable to:
upon coupling to the measurement device, transmit sensor information to the measurement device, wherein the sensor information comprises one or more of:
identification information for the sensor;
configuration information for the sensor; and
communication information for the sensor.

11. The measurement device of claim 1, wherein the power source comprises one or more of:
one or more batteries;
one or more fuel cells;
one or more photovoltaic cells; and
a microwave receiver for receiving microwave power transmissions.

12. The measurement device of claim 1, wherein the power source is operable to:
couple to an AC power adaptor, wherein the AC power adaptor is operable to:
couple to and receive AC power from an AC power source; and
convert the AC power to DC power;
receive the DC power from the AC power adaptor; and
provide the DC power to the measurement device.

13. The measurement device of claim 12, wherein the power source comprises a battery, and wherein the measurement device is operable to charge the battery with the DC power provided by the AC power adaptor.

14. The measurement device of claim 1, wherein the host computer comprises one or more of:
a personal computer;
a server;
a laptop computer; and
a personal digital assistant (PDA).

15. A method for performing measurement operations, comprising:
coupling a measurement device to one or more sensors, wherein the measurement device comprises:
a data acquisition (DAQ) board, comprising:
a microcontroller, comprising:
a processor;
a memory, coupled to the processor, wherein the memory is operable to store program instructions executable by the processor to perform a measurement function;
one or more ADC converters and/or one or more DAC converters, coupled to the processor; and
a plurality of digital lines, coupled to the processor;
a plurality of I/O connectors coupled to the processor and memory, wherein a first subset of the I/O connectors are coupled to the plurality of digital lines, wherein a second subset of the I/O connectors are coupled to the one or more ADC converters and/or the one or more DAC converters, and wherein the measurement device couples to the one or more sensors via one or more of the second subset of I/O connectors; and
a communication interface module, implementing a first communication protocol, and operable to:
couple to the DAQ board; and
provide for communication between the DAQ board and a host computer in accordance with the first protocol; and
a power source, coupled to the DAQ board, and operable to provide power to the DAQ board and the communication interface module;
receiving sensor data from the one or more sensors; and
transmitting the sensor data to the host computer via the communication interface.

16. The measurement device of claim 15, wherein the communication interface module comprises a wireless communication module, wherein the host computer comprises a wireless communication interface, wherein the wireless communication module facilitates wireless communication between the DAQ board and the host computer, and wherein said transmitting the sensor data to the host computer via the communication interface comprises wirelessly transmitting the sensor data to the host computer.

17. The method of claim 15, further comprising:
uncoupling the communication interface module from the DAQ board;
coupling a different communication interface module, implementing a second communication protocol; and
the DAQ board communicating with the host computer in accordance with the second protocol.

18. The method of claim 15, further comprising:
receiving one or more driver programs from the host computer over the communication interface module;
storing the received one or more driver programs; and
the processor executing the one or more driver programs to operate one or more of:
the DAQ board;
the communication interface module; and
the one or more sensors.

19. The method of claim 15, the method further comprising:
upon bootup of the measurement device, any host computer communicatively coupled to the measurement device that hosts the same communication protocol as the communication interface module detecting the measurement device.

20. The method of claim 15, wherein at least one of the one or more sensors comprises a smart sensor, the method further comprising:
upon coupling to the measurement device, transmitting sensor information to the measurement device, wherein the sensor information comprises one or more of:
identification information for the sensor;
configuration information for the sensor; and
communication information for the sensor.
